(19) United States
(12) Patent Application Publication
(10) Pub. No.: US 2009/0053676 A1
(43) Pub. Date: Feb. 26, 2009

(54) DENTAL RESTORATION WITH GOLD PLATING

(76) Inventor: William McCormick, Coloma, MI (US)

Correspondence Address: MICHAEL P. MAZZA, LLC, 686 CRESCENT BLVD., GLEN ELYN, IL, 60137, US

(21) Appl. No.: 11/844,034

(22) Filed: Aug. 23, 2007

(51) Int. Cl. A61C 13/09

(52) U.S. Cl. 433/207; 29/896.1; 433/223

(57) ABSTRACT

A gold-plated, full porcelain-coverage crown and a method to create that crown. The crown may be formed from a metallic coping mimicking the shape of the human tooth, such as one made from a nickel-chromium alloy. The intaglio of the crown is plated in gold. The exterior of the crown is covered in a ceramic material such as porcelain, and the interior of the crown or intaglio is plated in gold, and together this prevents exposure of the metallic alloy to the patient's mouth. The crown may be used for patients with an allergy to alloys such as nickel-chromium. Additionally, the crown is useful because it is affordable, contains only a small amount of gold, and is aesthetically pleasing.

### BACKGROUND OF THE INVENTION

The present invention generally relates to dental restorations. More particularly, the invention relates to a restoration, such as a “porcelain fused to metal” (PFM) restoration, the intaglio of which is plated in gold.

Various compositions for crowns are known. Typically, crowns have lingual collars, i.e. a band of polished alloy on the outside of the restoration or crown, as shown in FIG. 1A. The collar is made by providing an extra band of alloy on the exterior of the casting created from a lost wax or CAD/CAM process. Generally, the lingual collar is made of an alloy, such as nickel/chromium alloy. Its structure facilitates the crown's production by providing the dental technician with a convenient place to hold the crown throughout the manufacturing process. For example, the dental technician can grab the crown at the lingual collar with a pair of tweezers while adding a ceramic material such as porcelain to the rest of the exterior, avoiding any smudging of the ceramic material.

There are problems associated with crowns having lingual collars. It is well known that lingual collars made of chromium alloys (containing some percentage of nickel) cause an allergic reaction in a number of patients. When the patient's tissue contacts the alloy, the area may become inflamed and irritated. This is the same common allergic reaction that some individuals have to costume jewelry made of nickel, which can irritate and inflame the skin at the point of contact. Lingual collars are also not aesthetically pleasing to some patients because the polished metal band is visible in the mouth.

Ceramic crowns have been made without lingual collars, such that the entire outside of the restoration or crown is ceramic, and has a cast metal intaglio (so-called porcelain-fused-to-metal or “PFM” crowns). These crowns have been made with solid castings such as: chrome cobalt with nickel; a “noble” metal, i.e., palladium with a small amount of gold; or a “high noble” or half-gold metal. Full ceramic exterior crowns also suffer from problems. Like crowns with a lingual collar, ceramic crowns made of chromium alloy castings also cause an allergic reaction in a number of patients, as the alloy intaglio of the solid coping touches the patient's gum tissue. Further, castings made of gold, while not causing the same allergic reaction, may be cost-prohibitive.

It would be advantageous to create a ceramic crown that avoids causing allergic reactions and that is also aesthetically pleasing and affordable.

### Definitions of Claim Terms

The following terms are used in the claims of the patent as filed and are intended to have their broadest meaning consistent with the requirements of the law. Where alternative meanings are possible, the broadest meaning is intended. All words used in the claims are intended to be used in the normal, customary usage of grammar and the English language.

“Building” means the process of applying layers of ceramic material such as porcelain to the coping.

“Coping” means an alloy, made from either a lost wax technique or using CAD/CAM technology, that mimics the shape of the prepared tooth. The structure resulting from the lost wax process may also be referred to as a “casting.”

“Full ceramic exterior” means that the exterior portion of the crown is completely covered in a ceramic material such as porcelain.

“Gold plated” means a thin layer of gold (e.g., 24-carat gold) alloy covering the intaglio.

“Intaglio” means the interior surface portion of the crown, adjacent the human tooth which the crown covers. It is the portion of the alloy casting that is exposed and not covered by porcelain.

“Lingual collar” means a band that is located on the outside portion of the crown. It is generally made of the alloy that makes up the intaglio or solid casting.

“Nickel-chromium alloy” means a metal alloy with substantial amounts of nickel (e.g., 79%) and chromium (e.g., 11%), and possibly including lesser amounts of other metals (e.g., molybdenum, aluminum, beryllium, etc.).

“Opaquing” means the process of applying a first layer of ceramic material such as porcelain to the coping.

“Porcelain fused to metal” (PFM) means a type of restoration that uses an alloy casting as a base and a ceramic material such as porcelain which is layered and baked thereon to create a restoration that is made of ceramic and metal in one cohesive piece.

### SUMMARY OF THE INVENTION

The objects mentioned above, as well as other objects, are solved by the present invention, which overcomes disadvantages while providing new advantages not previously obtainable with such crowns.

In a preferred embodiment, a crown is made from a metallic coping by coating it entire exterior with a ceramic material such as porcelain, and by gold-plating its interior surface or intaglio. The resulting crown covers any patient exposure to the underlying metallic coping (e.g., a nickel-chromium alloy) along the gum line, as only ceramic and gold plating are in contact with the patient's mouth, sealing the mouth from exposure to the alloy, thus avoiding allergic reactions caused from patient exposure to the metallic coping. The crown appears like a natural tooth, and may be economically manufactured. Additionally, no metal can be seen in the patient's mouth and the crown may be made to appear like a natural tooth, so that the crown is aesthetically pleasing to patients both before (ceramic crown with gold intaglio visible) and after (ceramic crown exterior only visible) placement.

### BRIEF DESCRIPTION OF THE DRAWINGS

The novel features which are characteristic of the invention are set forth in the appended claims. The invention itself however, together with further objects and attendant advantages thereof, will be best understood by reference to the following description taken in connection with the accompanying drawings, in which:

FIG. 1 is a frontal view illustrating the opaquing of a coping;

FIG. 1A is a top-side view of a crown with a lingual collar, in the prior art;

FIG. 2 is a top view of the coping after the opaquing;

FIG. 3 is a frontal view illustrating the building of porcelain onto the coping;

FIG. 4 is a frontal view of the apparatus used to plate the coping;

FIGS. 5, 6, and 7 are a frontal view of individual steps in plating the coping;

FIG. 8 is a frontal view of the gold-plated intaglio;

FIG. 9 is a side view of the porcelain crown; and

FIG. 10 is a cross section along reference line 10-10 of FIG. 9.

The components in the drawings are not necessarily to scale, emphasis instead being placed upon clearly illustrating the principles of the present invention.

### DETAILED DESCRIPTION OF THE PREFERRED EMBODIMENT

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

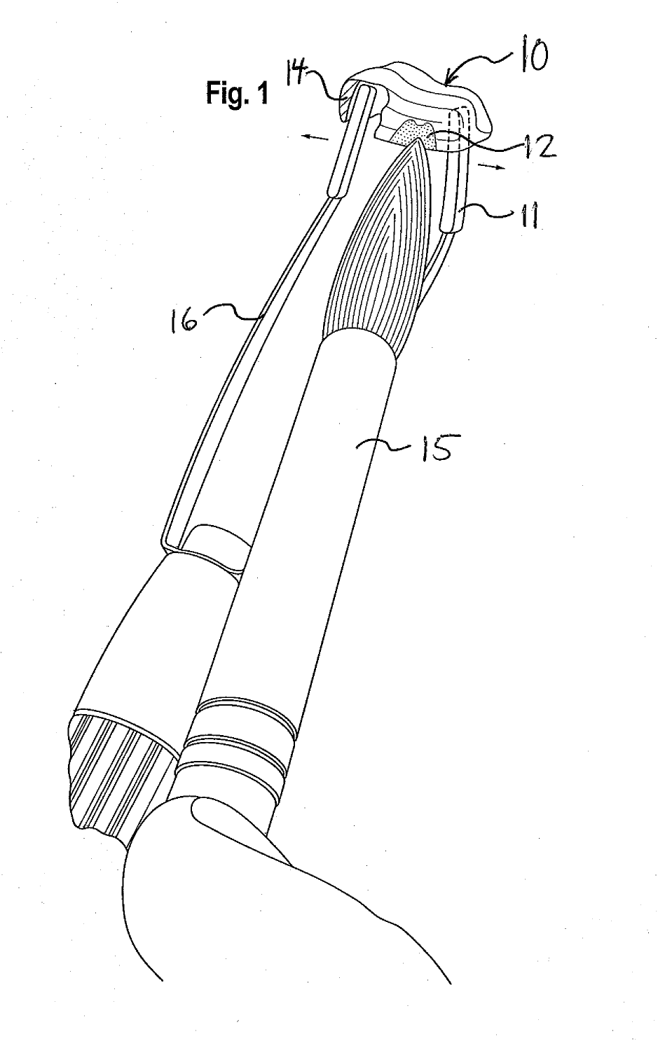

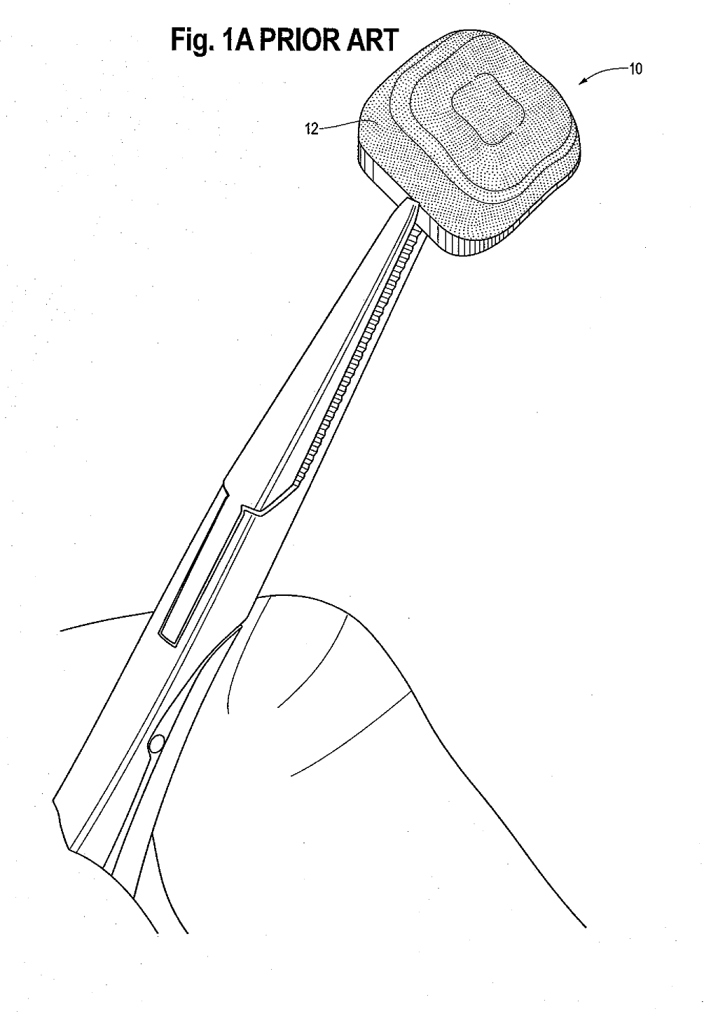

A coping 10, which may be made of an alloy, such as nickel/chromium alloy, is first made to mimic the prepared human tooth using an appropriate lost wax technique or CAD/CAM technology, as is well known in the art. Then, a ceramic material such as porcelain may be applied to the exterior of coping 10. FIG. 1 illustrates an opaquing technique, in which a double-pronged tweezers 16 may be employed, such that prongs 11 of the tweezers exert an outward force on the interior of the coping, holding it in place without touching the exterior portion. A brush 15 may be utilized to apply a layer of a ceramic material as such a porcelain 12 to the entire exterior of the coping.

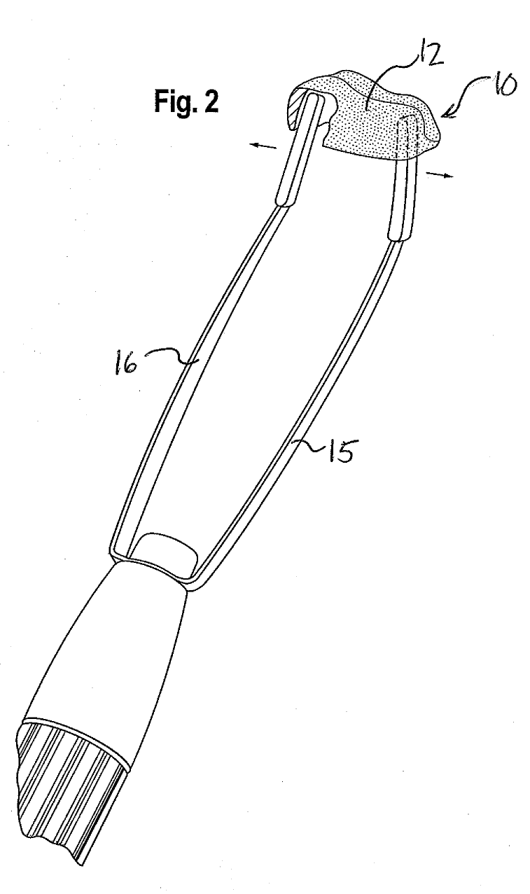

Referring to FIG. 2, a coping 10 is shown which results after opaquing, such that the exterior of the coping has been completely covered in a ceramic material such as porcelain 12. (Throughout this remaining section, reference to porcelain will be made, but artisans will understand that other ceramic materials may be used.)

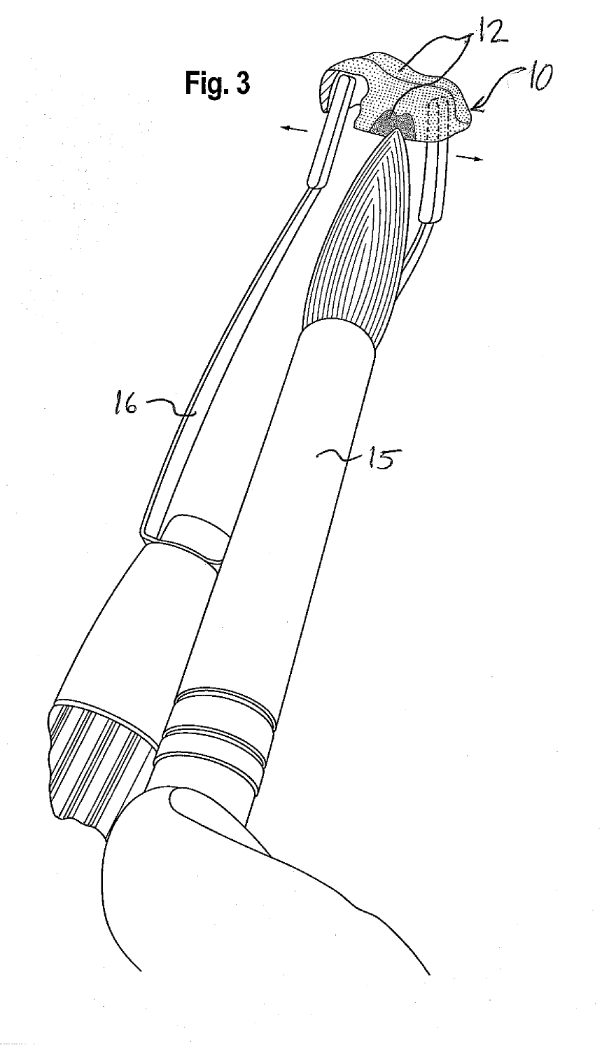

Referring to FIG. 3, the building of porcelain 12 around coping 10 is shown. To continue the process, porcelain 12 may be layered on the entire exterior of coping 10 to increase the size of the structure and mimic the size and shape of the patient's tooth that is being replaced. Again, tweezers and a brush may be used to complete the building process.

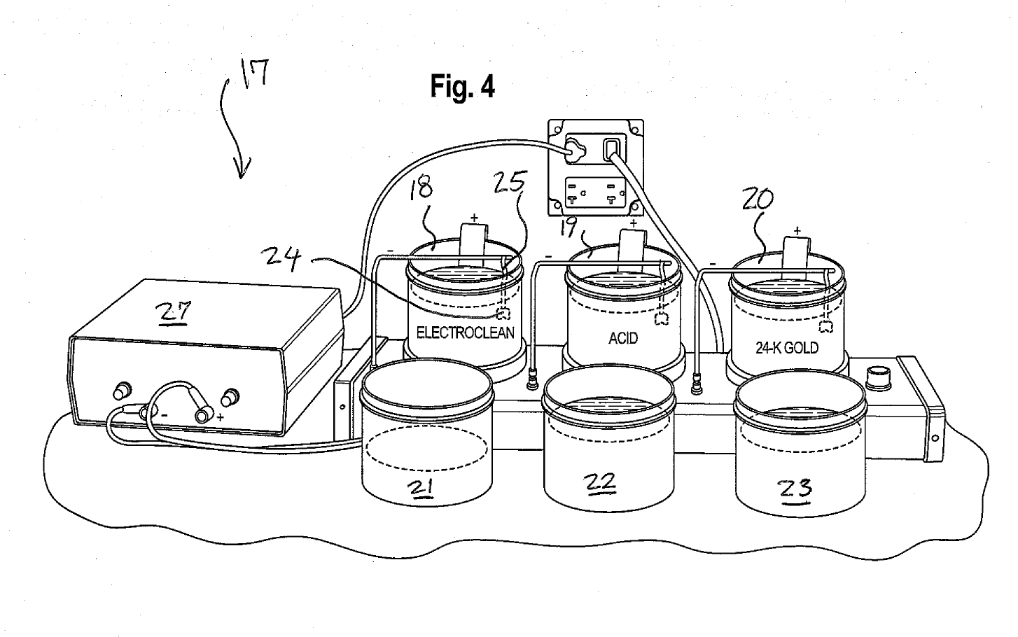

FIG. 4 illustrates a system 17 which may be used to plate the intaglio of the crown with gold. A voltage amount may be applied to clip 25, set using voltage machine 27, based on the number of crowns being plated. Three (3) liquids may be used for the plating process, each in a separate tub: electro-clean 18; acid 19; and (e.g.) twenty-four (24) carat gold solution 20. (Of course, any desired number of gold carats may be used to plate the intaglio of the coping for a particular dental application, and given cost considerations.) Three tubs 21, 22, and 23 may be located in front of each solution, each filled with distilled water.

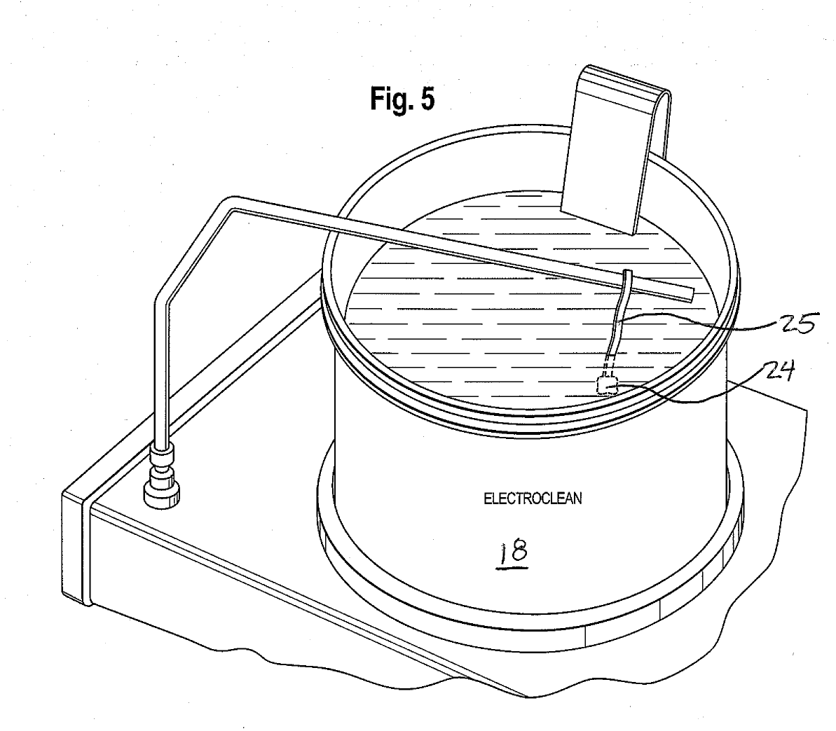

Referring to FIGS. 5 and 6, the first step in plating crown 24 with gold is shown. After crown 24 is sand-blasted clean, it may be placed on plating clip 25 and then dipped in electro clean solution 18 for about (e.g.) 30-45 seconds. Immediately thereafter, the crown may be placed in the tub of distilled water 21 to rinse off excess solution.

Referring to FIG. 4 again, in a step not pictured, crown 24 on plating clip 25 may be dipped into an acid solution 19 for about (e.g.) 30-45 seconds. Immediately thereafter, the crown may be placed in distilled water container 22 to rinse off excess solution.

FIG. 7 illustrates the last step in the plating process. Crown 24 may be dipped into a (e.g.) twenty-four carat gold plating solution for about (e.g.) 60 seconds. Immediately thereafter, the plated crown may be placed in distilled water to rinse off excess solution. Because the plating clip covers a portion of the intaglio, the crown will need to be adjusted on the clip and reinserted into the plating solution and water to make sure the entire intaglio is plated.

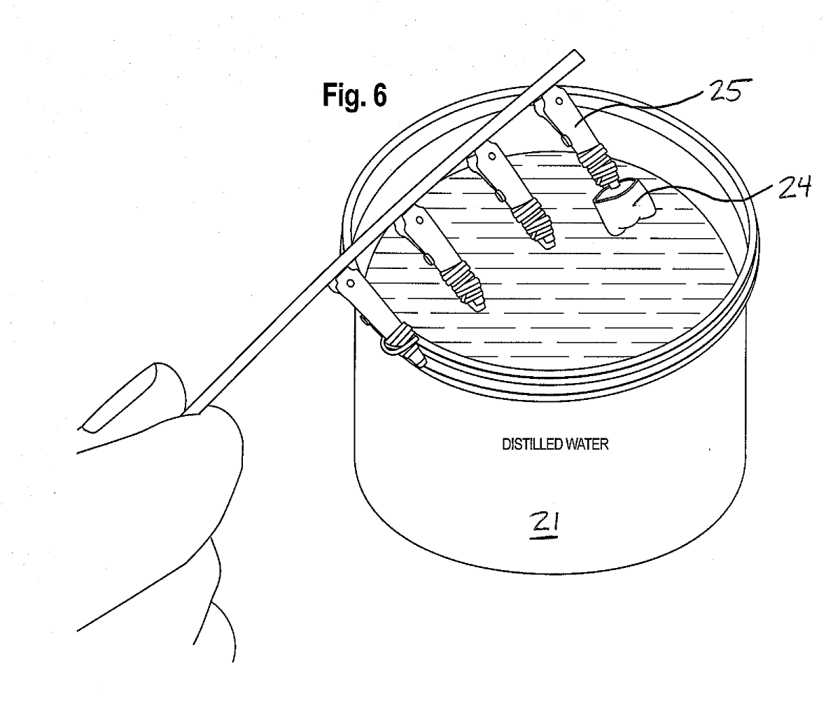

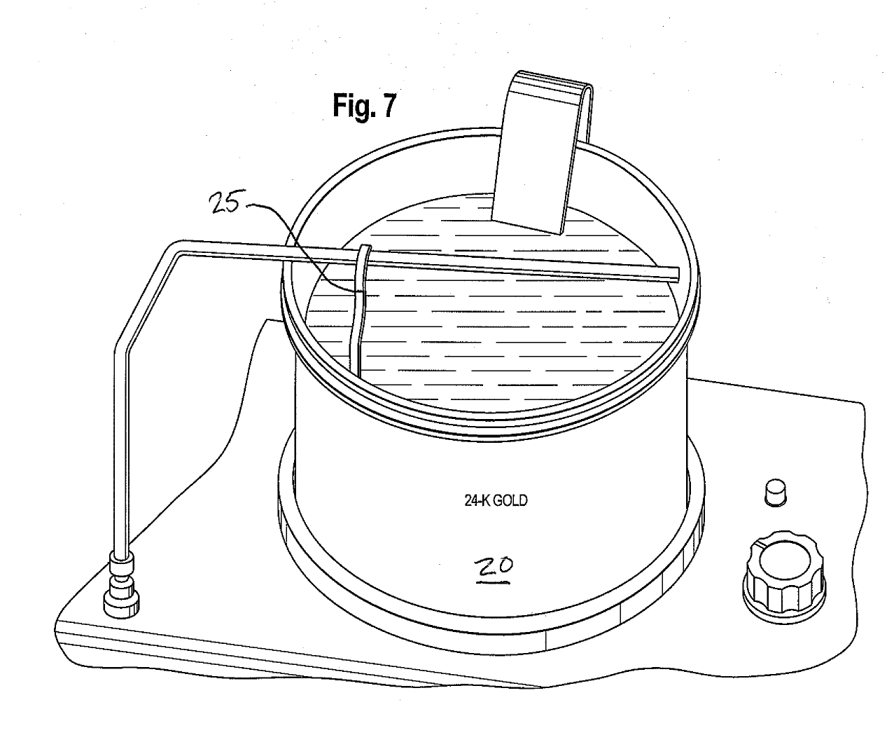

Referring to FIGS. 8 and 9, a preferred embodiment of the invention is a full porcelain crown 24 with a gold-plated intaglio 26. The crown covers the human tooth portion, and the gold-plated intaglio contacts and seals off the human tooth portion from contact with the nickel/chromium (or other) alloy.

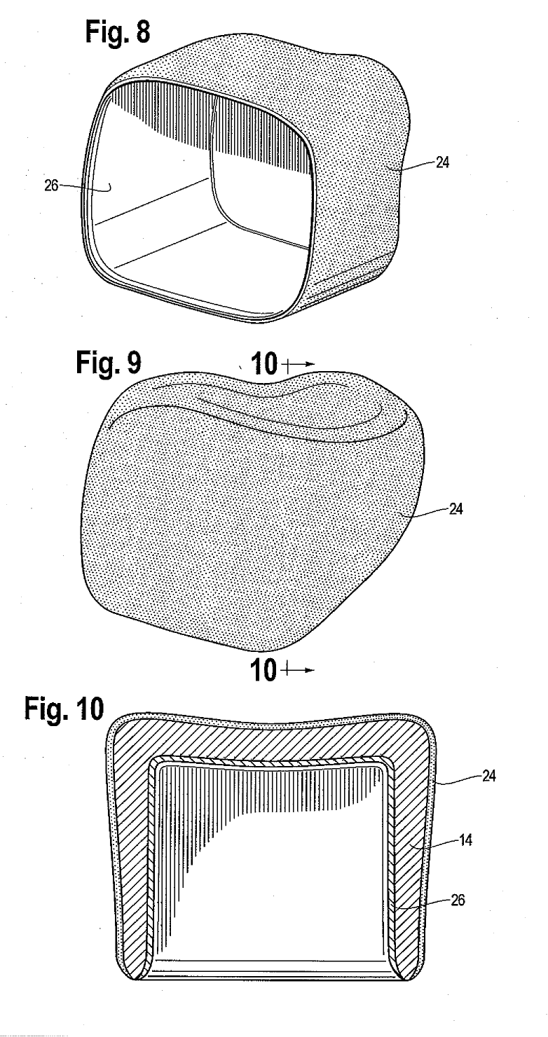

FIG. 10 is a cross section of FIG. 9, showing a top layer of a ceramic material such as porcelain 24 lying over an alloy casting 14 plated in gold 26.

The above description is not intended to limit the meaning of the words used in the following claim that define the invention. For example while preferred embodiments involving full porcelain crowns with gold plated intaglios have been described above, persons of ordinary skill in the art will understand that a variety of other designs still falling within the scope of the following claims may be envisioned and used. It is contemplated that future modifications in structure, function, or result will exist that are not substantial changes and that all such insubstantial changes in what is claimed are intended to be covered by the claims.

I claim:

1. An artificial dental restoration, comprising:
a metallic coping having a fill ceramic exterior and an intaglio covered by gold plating.

2. The restoration of claim 1, wherein the metallic coping comprises a nickel-chromium alloy.

3. The restoration of claim 1, wherein the intaglio is plated with twenty-four carat gold.

4. The restoration of claim 2, wherein the intaglio is plated in gold after the exterior of the metallic coping is covered in a ceramic material.

5. The restoration of claim 1, wherein the ceramic exterior comprises porcelain.

6. The restoration of claim 1, wherein the restoration comprises a crown, or a plurality of crowns comprising a bridge.

7. The restoration of claim 1, wherein the restoration comprises a PFM restoration.

8. A method for creating an artificial dental crown, comprising the steps of:
providing a metallic coping mimicking the shape of a human tooth, the coping have an exterior surface and an interior surface or intaglio;
building ceramic material on the coping so that the entire exterior surface area of the coping is covered by the ceramic material; and
plating the intaglio of the coping with gold, wherein no part of the metallic coping is exposed in a patient's mouth when the crown is fitted on the patient.

9. The method of claim 8, wherein the ceramic material comprises porcelain.

10. The method of claim 8, wherein the metallic coping comprises a nickel/chromium alloy.

11. The method of claim 8, wherein the gold comprises twenty-four carat gold.

12. The method of claim 8, wherein the gold comprises a noble or high-noble alloy.

13. The method of claim 8, wherein the resulting dental crown comprises a PFM crown.
